(19) United States
(12) Patent Application Publication
(10) Pub. No.: US 2009/0101559 A1
(43) Pub. Date: Apr. 23, 2009

(54) Microconcentrator/Microfilter

(76) Inventors: Anand Bala Subramaniam, Cambridge, MA (US); Manouk Abkarian, Montpellier (FR); Adrien Fabre, Paris (FR); Marc Durand, Paris (FR); Howard A. Stone, Cambridge, MA (US)

Correspondence Address: WOLF GREENFIELD & SACKS, P.C., 600 ATLANTIC AVENUE, BOSTON, MA, 02210-2206, US

(21) Appl. No.: 11/795,612

(22) PCT Filed: Jan. 20, 2006
(86) PCT No.: PCT/US2006/002229

§ 371 Date: Apr. 14, 2008

Related U.S. Application Data
(60) Provisional application No. 60/645,673, filed on Jan. 21, 2005.

(51) Int. Cl. B01D 15/34; B01D 35/00; B01D 57/00; B01D 67/00; B01D 24/02

(52) U.S. Cl. 210/194; 210/483; 210/291; 210/222; 210/323.1

(57) ABSTRACT

The present invention includes a microfluidic filter and concentrator that can separate a filtrate from a fluid containing components, e.g. a suspension of particles, to be removed from the fluid at least to some extent. The filter may employ principals of tangential flow filtration, also known as cross-flow filtration. In one aspect, a microfluidic filter described herein includes at least a first, main channel and one or more secondary, filtering channels that connect to the main channel. Filtration occurs when a fluid portion of a sample that is flowed through the main channel enters one or more of the filtering channels and at least some of the components in the sample do not enter or do not flow through the secondary, filtering channels. The secondary channels may be dimensioned to inhibit flow of components through them, and/or a porous material such as a layer may be positioned to inhibit flow of components through the secondary channels.

### FEDERALLY SPONSORED RESEARCH

Various aspects of the present invention were sponsored by the National Science Foundation, grant no. DMR-0213805. The Government may have certain rights in the invention.

### FIELD OF INVENTION

The invention relates to methods and apparatuses for filtration, and/or concentration of fluids such as suspensions and, in particular, to filtration and concentration via tangential flow.

### BACKGROUND

Fluidic systems, including microfluidic systems, have found application in a variety of fields. These systems that typically involve controlled fluid flow through one or more microfluidic channels can provide unique platforms useful in both research and production. For instance, one class of systems can be used for analyzing very small amounts of samples and reagents on chemical “chips” that include very small fluid channels and small reaction/analysis chambers. Microfluidic systems are currently being developed for genetic analysis, clinical diagnostics, drug screening, and environmental monitoring. These systems can handle liquid or gas samples on a small scale, and are generally compatible with chip-based substrates. The behavior of fluid flow in these small-scale systems, therefore, is central to their development.

Separation of substances is one area in which microfluidics is being applied. Often in the fields of healthcare, chemical analysis and environmental testing, for example, it is useful to separate substances that are contained in a fluid. For example, different separation techniques can be used to purify water and to separate cells from body fluids. These techniques typically require substantial capital equipment that can be both expensive and bulky, thus limiting where and when the separation can take place. Advances in the field that could, for example, reduce costs and/or increase portability would find application in a number of different fields.

### SUMMARY OF THE INVENTION

The present invention relates to methods and apparatus for filtration, and/or concentration of fluids such as suspensions and, in particular, to filtration and concentration in microfluidic systems which can involve tangential flow.

In one embodiment, the present invention is directed to a microfluidic filter, comprising a polymeric structure comprising a first microfluidic channel having an inlet and an outlet, and a second microfluidic channel in fluid communication with the first channel and with a first filtrate outlet, the second channel having at least a first cross-sectional dimension that is smaller than a cross-sectional dimension of the first channel.

In another embodiment, the present invention is directed to a method, comprising flowing a suspension comprising a fluid and at least a first component through a first microfluidic channel of a substantially polymeric microfluidic filter, allowing a portion of the fluid to pass through at least a second channel in fluid communication with a filtrate outlet, preventing the component from passing through the second channel, and collecting the portion of the fluid from the filtrate outlet.

In another embodiment, the present invention is directed to a microfluidic filter, comprising a first microfluidic channel having an inlet and an outlet, at least a second channel in fluid communication with the first channel, a porous material positioned to inhibit flow of certain components through at least a portion of the second channel, and at least a first filtrate outlet in fluid communication with the second channel.

In another embodiment, the present invention is directed to a method, comprising flowing a suspension comprising a fluid and at least a first component through a first microfluidic channel of a microfluidic filter, allowing a portion of the fluid to pass through at least a second channel, wherein at least a portion of the second channel comprises a porous material, preventing the component from passing through the porous material, and collecting the portion of the fluid in a first filtrate outlet that is in fluid communication with the second channel.

In another embodiment, the present invention is directed to a microfluidic filter, comprising a first microfluidic channel having an inlet and an outlet, a second channel in fluid communication with the first channel, the second channel having at least a first cross-sectional dimension that is smaller than a cross-sectional dimension of the first channel, at least a first filtrate outlet in fluid communication with the second channel, and a third channel that is separated from the second channel by the first channel, the third channel having at least a second cross-sectional dimension that is smaller than a cross-sectional dimension of the first channel.

In another embodiment, the present invention is directed to a method, comprising flowing a suspension comprising a fluid and at least a first component through a first microfluidic channel of a microfluidic filter, allowing a first portion of the fluid to pass through a second channel, preventing the component from passing through the second channel, allowing a second portion of the fluid to pass through a third channel, wherein the third channel is separated from the second channel by the first channel, and preventing the component from passing through the third channel.

In another embodiment, the present invention is directed to a method of forming a porous material in a microfilter, the method comprising flowing a suspension comprising a plurality of particles through a first microfluidic channel of a microfluidic filter, and retaining at least a portion of the particles in a second channel to form the porous material.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 illustrates schematically a microfluidic filter according to one embodiment of the present invention;

FIG. 2 illustrates schematically a cutaway side view of the microfluidic filter of FIG. 1;

FIG. 3 illustrates, via a black and white photocopy of a fluorescent micrograph, a section of a microfluidic filter showing entry of filtrate into a filtrate collection channel according to one embodiment of the present invention;

FIG. 4 illustrates, via a black and white photocopy of an optical micrograph, the progression of microspheres in a channel in a section of a microfluidic filter according to one embodiment of the present invention;

FIG. 5 illustrates, via a black and white photocopy of an optical micrograph, the formation of a porous material in a section of a microfluidic filter according to one embodiment of the present invention;

FIG. 6 illustrates, via a black and white photocopy of an optical micrograph, the filtration of whole blood to obtain plasma in a section of a microfluidic filter according to one embodiment of the present invention;

FIG. 7 illustrates graphically the relationship between efficiency of a microfluidic filter and driving pressure according to one embodiment of the present invention.

### DETAILED DESCRIPTION

The present invention includes a microfluidic filter and concentrator that can separate a filtrate from a fluid containing components, e.g. a suspension of particles, to be removed from the fluid at least to some extent. The filter may employ principals of tangential flow filtration, also known as cross-flow filtration.

In one aspect, a microfluidic filter described herein includes at least a first, main channel and one or more secondary, filtering channels that connect to the main channel. Filtration occurs when a fluid portion of a sample that is flowed through the main channel enters one or more of the filtering channels and at least some of the components in the sample do not enter or do not flow through the secondary, filtering channels. The secondary channels may be dimensioned to inhibit flow of components through them, and/or a porous material such as a layer may be positioned to inhibit flow of components through the secondary channels. For example, a filtering channel (defining a secondary channel) may comprise a cross-sectional dimension and/or a porous layer that enables separation of components in a liquid solution or suspension based on, for example, size, charge differences, or differences in chemical structure. Clogging may be less of a problem using this device than with conventional filters, since the build up in the secondary channel(s) of components removed during the filtration process may be avoided, and instead the components can be swept away through the main channel. In addition, in some embodiments the pressure at which the suspension is driven through the channels may determine the rate at which the filtrate is collected and may not affect the fraction of the fluid collected. Therefore, the device can be run at high driving pressures to obtain samples more quickly without affecting the performance of the device. Flow rates and driving pressures similar to those in known tangential flow systems have been duplicated or exceeded in the microscale. Filter systems can be scaled up to increase capacity.

The filter disclosed herein has many applications and can be applied to fields such as, for example, immunology, protein chemistry, molecular biology, biochemistry, and microbiology. For instance, the filter can be used to concentrate sample solutions, filter colloidal suspensions (particulate size less than 1 micron), harvest cell suspensions, clarify suspensions of cells, and extract plasma from whole blood, which can be important for developing point of care medical diagnostics. The device can be used as continuous-monitoring systems, such as ones for quality testing, and can be easily integrated with microfluidic systems, such as Lab-on-a-Chip or Micro Total Analysis (microTAS) Systems.

A variety of definitions are now provided, which will aid in the understanding of the invention. Following is further disclosure including additional aspects and embodiments that will more fully describe the invention.

“Structure”, as used herein, refers to a configuration (which can be a microfluidic configuration) comprising any shape or material that is suitable for defining fluid pathways according to the present invention. For example, a structure can be in the form of a block, a membrane, a tube, and the like.

“Microfluidic channel system,” as used herein, refers to a device, apparatus or system including at least one fluid path, at least a portion of which includes a cross-sectional dimension of less than 1 millimeter (mm).

“Fluid path,” as used herein, refers to any channel, capillary, tube, pipe or pathway defined in a structure through which a fluid, such as a liquid, may pass. The fluid path can be microfluidic. “Fluid path”, “flow path”, and “channel” may be used interchangeably herein.

“Cross-sectional dimension,” as used herein, refers to the shortest distance that can be measured between any two opposed points of a surface, or surfaces, of a fluid path.

“Fluid,” as used herein, is defined by the property of being able to flow and can include a material that is in the liquid state or gaseous states. A fluid may comprise a suspension and/or an emulsion of particles.

“Filtrate,” as used herein, refers to any fluid that has passed through a filter and has undergone at least some loss of components from the fluid via the filtration process. A filtrate may be a reduced-particle or a particle-free fluid.

“Component” to be removed from a fluid with a filter or according to a filtration process of the invention, refers to a discrete substance that can be separated from a fluid in which it is dissolved, suspended or otherwise retained. Components may be, for example, cells, precipitates or other particles, impurities, or the like.

“Porous material”, “porous article”, and “porous layer” as used herein, refer to a material that is permeable to a fluid, but which may exclude (inhibit, partially or fully, the passage of) one or more component(s) in the fluid, such as a particle. A porous material may be disposed in a channel or a portion of a channel. It may have any geometry or dimension and can vary depending on the application. A porous material may exclude one or more component(s) in a fluid, for example, based on size, charge, van der Waals interactions, hydrophilic or hydrophobic interactions, magnetic interactions, or the like.

The invention provides a microfluidic channel system that can be formed in a structure which may comprise any shape or material that is suitable according to the use to which the present invention is to be put. Those of ordinary skill in the art can readily select a suitable material based upon, e.g., its inertness to (freedom from degradation by) a fluid to be passed through it, its robustness at a temperature at which a particular device is to be used, etc. For example, if desired, the structure can be in the form of a block, a membrane, a tube, or the like. In one embodiment of the invention, the structure is formed of a polymer. In some instances, the polymer may be an elastomer. In one particular embodiment, the elastomer comprises poly(dimethylsiloxane) (PDMS). Alternatively, the polymer may be a rigid polymer such as polystyrene or polycarbonate. The structure may also be formed of non-polymers; non-limiting examples of such include silicon and glass. Multiple materials can be used, for example a block of material can include passageways therethrough lined with a second material defining channels.

In one embodiment, a first fluid flow path within a structure can optionally comprise a series of channels, at least some of which may be interconnected. In another embodiment, a second fluid flow path can be present within the microfluidic channel system. The second fluid flow path can, in some cases, be fluidically interconnected with the first fluid path, and may lie on the same or a different plane as the first fluid path.

It is noted that the channels need not be straight, but can follow a non-linear path such as a curved, serpentine, zig-zag, or other path shape. The fluid flow paths, or a portion of the paths, may be microfluidic and have a maximum cross-sectional dimension of less than about 1 millimeter (mm) in some cases, less than about 500 microns, less than about 300 microns, less than about 100 microns, less than about 50 microns, less than about 30 microns, less than about 10 microns, less than about 3 microns, or less than about 1 micron in other cases. It should be recognized that the cross-sectional dimension of each fluid path can vary with the fluid(s) and the application. The fluid paths can have any suitable cross-sectional shape that allows for fluid transport, for example, a square channel, a circular channel, a rounded channel, a rectangular channel (e.g., having any aspect ratio), a triangular channel, an irregular channel, etc. Of course, the number of channels, the shape or geometry of the channels, and the placement of channels within the system can be determined based on the specific application. As discussed below, a microfluidic channel system may be fabricated by methods known to those of ordinary skill in the art.

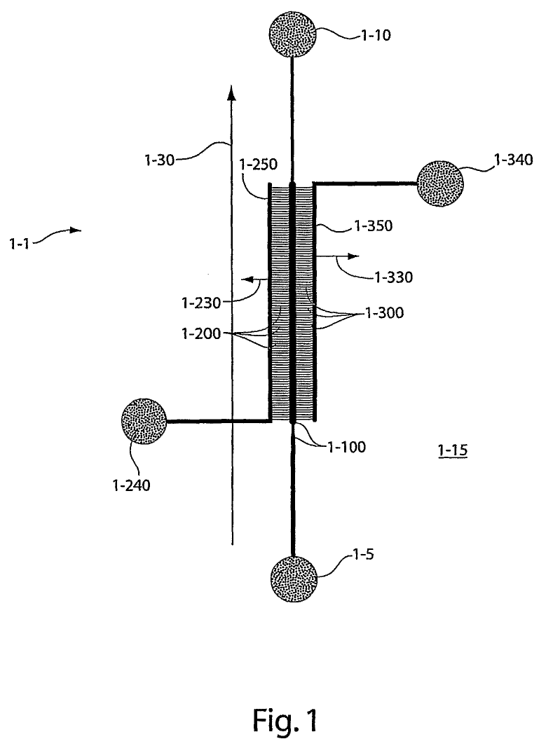

One aspect of the invention provides systems and methods of forming a microfilter, e.g., a microfluidic filter, as shown in the embodiment illustrated in FIG. 1. In FIG. 1 a filter 1-1 can be formed in a structure 1-15, which may comprise any configuration or material, as discussed above. As shown, filter 1-1 has a filter inlet 1-5 and a filter outlet 1-10 which can receive and expel a fluid. Inlet 1-5 and outlet 1-10 are in fluid communication through a first, main, channel 1-100 which can be microfluidic. As shown in FIG. 1, inlet 1-5 and outlet 1-10 are connected via a single channel 1-100. However, in other embodiments, filter 1-1 may include additional inlets and outlets and/or additional microfluidic channels, such as additional main channels, each of which may be in fluid communication with channel 1-100, and/or independent from channel 1-100. FIG. 1 shows channel 1-100 being straight, but it can be curved, meandering, or have other configurations and/or geometries, such as branching, depending on the application.

In the embodiment illustrated in FIG. 1, a second microfluidic channel 1-200 is in fluid communication with first channel 1-100. As illustrated, second channel 1-200, the purpose of which is described below, is perpendicular to first channel 1-100, however, second channel 1-200 may be configured at any angle relative to first channel 1-100, such as at ≧30 degrees, ≧60 degrees, ≧120 degrees, ≧150 degrees, or 180 degrees relative to first channel 1-100.

The second channel is in fluid communication with a filtrate outlet, through which filtrate can be removed. In the embodiment of FIG. 1, second channel 1-200 is in fluid communication with a first filtrate outlet 1-240. In some cases, filter 1-1 may comprise a plurality of secondary channels 1-200 in fluid communication with first channel 1-100 and first filtrate outlet 1-240, and this is illustrated in FIG. 1. For example, filter 1-1 may comprise greater than 10 additional channels (such as secondary channels, which can be essentially identical to each other), greater than 100 additional channels, or greater than 1000 additional channels, that may be in fluid communication with the first channel 1-100 and the first filtrate outlet 1-240. A filter may also comprise different densities of secondary channels. For instance, to make a filter more efficient, a filter may comprise a high density of (i.e., closely packed) secondary channels, or secondary channels having a greater width. For example, adjacent secondary channels may be separated by less than 10, less than 5, less than 2, less than 1, or less than 0.5 channel widths.

In one embodiment, one or a plurality of secondary channels 1-200 may be in fluid communication with a first filtrate collection channel 1-250. As in the embodiment illustrated, first filtrate collection channel 1-250 may be in fluid communication with first filtrate outlet 1-240, for example by fluidly connecting the secondary channels to the filtrate outlet, and can be used to gather filtrate from a number of secondary channels. In another embodiment, e.g., as shown in FIG. 1, a second filtrate collection channel 1-350 may be in fluid communication with first channel 1-100 via another set of secondary channels 1-300. Channels 1-300 (or a single channel 1-300) may be separated from second channel 1-200 by first channel 1-100 so that, for example, filtrate flowing through channel 1-300 may flow in a direction substantially opposite to direction of flow in channel 1-200 while being fed by the same first channel 1-100. In some instances, many channels may be disposed between second filtrate collection channel 1-350 and first channel 1-100. For example, a filter 1-1 may comprise greater than 10, greater than 100, or greater than 1000 additional channels in fluid communication between second filtrate collection channel 1-350 and first channel 1-100.

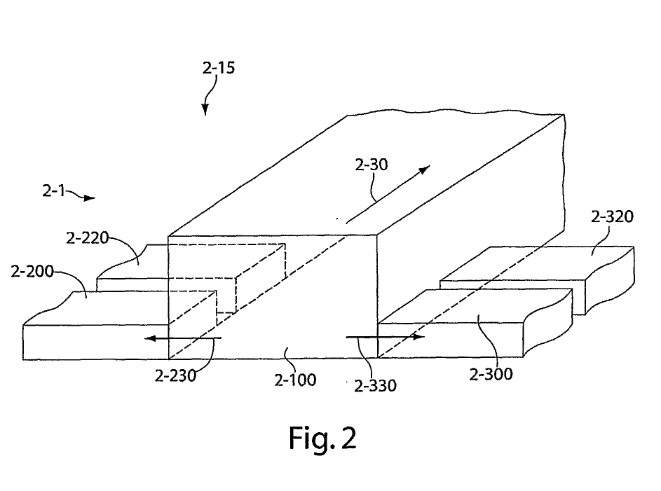

Referring now to FIG. 2, one embodiment of a first channel and a series of second channels, each connected to the first channel, is illustrated. In FIG. 2, second channel 2-200 may have at least a portion having a first cross-sectional dimension that is smaller than a cross-sectional dimension of the first channel 1-100. As illustrated, secondary channels 2-200 and 2-220 have a cross-sectional dimension, e.g., a height, that is smaller than a second cross-sectional dimension, e.g., the height, of first channel 2-100. Opposing channels 2-300 and 2-320 also have a cross-sectional dimension, e.g., a height, that is smaller than that of first channel 2-100. Cross-sectional dimensions of channels 2-200 and 2-220 may be the same or different from each other, and/or from channels 3-300 and 2-320. Cross-sectional dimensions of any of these channels can vary along the length of the channel; for instance, some of the channels may be tapered, typically extending from a larger to a smaller diameter in the direction of flow but with the reverse geometry or other geometry also possible.

In use, according to one embodiment, a sample such as a suspension comprising a fluid and a particle or other component to be removed from a fluid may be introduced (referring to FIG. 1) into filter 1-1 via inlet 1-5. The suspension flows in channel 1-100 in the direction indicated by arrow 1-30. A portion of the suspension, generally more concentrated in the component to be removed from the fluid by the filter relative to the component's concentration at inlet 1-5, may be collected at outlet 1-10. A second portion of the suspension may flow tangentially to the direction of arrow 1-30, for example, in the direction indicated by arrows 1-230 and/or 1-330 through secondary channels 1-200 and 1-300. In one embodiment, particles of the suspension having diameters that are larger than a cross-sectional dimension of the channels 1-200 or 1-300 may be excluded from entry into channels 1-200 and 1-300, and therefore may be contained within channel 1-100 and can be collected at outlet 1-10. A portion of the filtrate may pass through second channel 1-200 and may be collected at first filtrate outlet 1-240. A second portion of the filtrate may pass through channel 1-300, and can be collected at second filtrate outlet 1-340. Clogging in filter 1-1 may be minimized because particles of the suspension may be too large to enter channels 1-200 and 1-300, and therefore may not build up in these channels; instead they may flow through first channels 1-100 and may be collected at outlet 1-10. As a result, particles may be more concentrated farther along channel 1-100.

As shown in FIG. 1, filtrate outlets 1-240 and 1-340 are separate. However, in other embodiments, they may be connected and form a single filtrate outlet. In one embodiment, a plurality of filtrate outlets 1-240 may be in fluid communication with first filtrate collection channel 1-250. In another embodiment, a plurality of secondary filtrate outlets 1-340 may be in fluid communication with second filtrate collection channel 1-350. In some cases, a filter may comprise any combination of the above.

In another embodiment of the invention, a filter may include multiple stages of filtration. For example, a filter may comprise a first microfluidic channel having an inlet and an outlet, and a second microfluidic channel in fluid communication with the first channel and with a first filtrate outlet, and comprising a first section having a first cross-sectional urea and a second section having a second cross-sectional area, wherein the first cross-sectional area is smaller than the second cross-sectional area. The second channel (or other channel of the filter) may further comprise a third, a fourth, or a plurality of sections, each section having a cross-sectional area that is successively smaller than the previous cross-sectional area. A suspension of particles having a range of distribution of sizes may therefore be filtered more efficiently in this manner, than with a device comprising a single stage of filtration (single difference in cross-sectional dimension in a microfluidic channel array, and/or containing a porous material as described below).

In another example of a filter comprising multiple stages of filtration, a filter may comprise a main channel such as channel 1-100 of FIG. 1, one or more secondary (filtering) channels such as channels 1-200 and/or 1-300 of FIG. 1 emanating from the main channel (the filtering channel(s) being of first cross-sectional area, for example, inhibiting flow of components from the main channel into the filtering channel), a first filtrate collection channel, such as channel 1-250 or 1-350 of FIG. 1, positioned to receive fluid from the secondary, filtering channel(s) and having a first filtrate outlet, and may further comprise a third, filtering channel (or series of third channels) having a second cross-sectional area less than the first cross-sectional area (and/or comprising a finer porous article, described below), fluidly connected to and positioned to receive fluid from the first filtrate collection channel. In this filter, a first fluid, e.g., a first filtrate, may be collected at the first filtrate outlet and a second fluid, e.g., a second filtrate, may be collected from an outlet of the third channel (e.g., an outlet of a second filtrate collection channel positioned to receive filtrate from the third channel(s)). The second filtrate may be free of components such as particles that were inhibited from passage through the third channels, but that might have passed through the secondary (filtering) channel(s) and been collected in the first filtrate collection channel/first filtrate outlet, i.e., the filter defines two stages of filtration. The first filtrate may be free of particles that were too large to pass through the second channel, but may comprise particles passed through the second channel and not the third channel. Of course, filters comprising a third, a fourth, or a plurality of filtrate outlets may exist where each of these filtrate outlets are in fluid communication with the first channel, and may have a cross-sectional dimension that successively decreases after each stage of filtration. A filter may optionally comprise a plurality of additional channels in fluid communication between each stage of filtration; for example, the filter may include greater than 10, greater than 100, or greater than 1000 additional channels.

In another embodiment, the invention provides a microfluidic filter comprising a porous material, which may enable filtering of smaller particles of a suspension than would be possible with a similar filter that does not comprise a porous material. A porous material may be used in conjunction with any of the microfluidic filters described herein. A filter without a porous material can filter particles of a suspension determined at least in part by the cross-sectional area of the secondary or other filtering channels stemming from the first channel. A filter comprising a porous material such as a porous layer, however, can filter particles of a suspension determined by the pore size of the porous layer in the secondary channels. The porous article can be a membrane, mesh, or the like, or can be defined by a close association (e.g., packing) of particles. Different pore sizes may be fabricated by using different sizes of particles, or a combination of different sizes of particles, in the porous article. Porous articles may be permanent or temporary and in some cases may be formed using the hydraulic pressure of the filter system. Typically, a porous article is disposed in, on, or adjacent to a secondary channel and often is located at the junction of the secondary channel and the primary, or main channel. For instance, the porous material typically is positioned to inhibit flow of components such as particles greater than a predetermined size through the secondary channel, while allowing flow of those particles in the main channel.

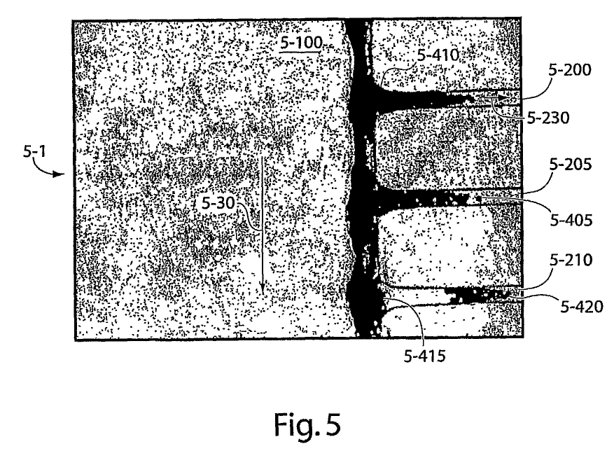

Accordingly, one embodiment of the invention includes a microfluidic filter comprising a first microfluidic channel having an inlet and an outlet, at least a second channel in fluid communication with the first channel, a porous material disposed in a least a portion of the second channel, and at least a first filtrate outlet in fluid communication with the second channel. A non-limiting example of such a filter is shown in FIG. 5. As illustrated in FIG. 5, a main channel 5-100 leads to a series of emanating secondary channels 5-200, 5-205, and 5-210, of cross-sectional area smaller than that of the main channel, and a porous material is provided at the intersections defined by the main channel and the secondary channels. Porous layers such as 5-410, 5-415, and 5-420, may be formed in filter 5-1 by flowing a suspension comprising a plurality of particles 5-405 through a first microfluidic channel 5-100. Direction of the flow of the suspension in channel 5-100 is shown by the arrow 5-30. Flow of the suspension may also occur in channels 5-200, 5-205, and 5-210, the flow being tangential to 5-30, as can be seen by arrow 5-230. At least a portion of the particles 5-405 may be retained in at least a portion of channels 5-200, 5-205 and 5-210 to form the porous layer, and this can be due to the particles collecting at and jointly forming a packed structure at the intersections, as shown, even where each particle defining the porous material, individually, would be able to pass through any secondary channel. Those of ordinary skill in the art can select particles of appropriate size, in conjunction with the size of the channels involved, concentration of particles, carrier fluid, flow rate, and/or other factors, to form such a porous material. In some cases, a soft and/or flexible and/or polymeric (e.g., elastomeric) material defining the walls of the channels (or the entire article(s) defining the channels) can better facilitate formation of a collection of particles defining a porous article at a location where a cross-sectional dimension of a microfluidic system decreases, e.g. at an intersection of a larger channel with a smaller one. For example, as shown in FIG. 5, porous layer 5-415 can form near an inlet of a channel 5-210. Porous layer 5-420 can form inside channel 5-210, or porous layer 5-410 can form both at an inlet, and in a portion of, channel 5-200. Geometry of a channel can also facilitate porous material formation in a microfilter. For example, a second channel may include a tortuous or serpentine section, e.g., a sharp curve, that can aid in capturing particles to form a porous material.

A particle having any of a variety of suitable sizes, shapes, dimensions, or composition may be used to form a porous material. For example, in the embodiment shown in FIG. 5, a porous layer may comprise particles 5-405 having a diameter less than both a cross-sectional dimension of a first channel 5-100 and a cross-sectional dimension of a second channel 5-405. In another embodiment, the porous layer may comprise a particle having a diameter less than a cross-sectional dimension of a first channel and greater than a cross-sectional dimension of a second channel. In some instances, a particle may have a diameter of less than about 100 microns. In other instances, a particle may have a diameter of less than about 50 microns, less than about 25 microns, less than about 5 microns, less than about 1 microns, less than about 0.1 microns, or less than about 50 nm. A porous material comprising packed particles may have an average pore size that is less than the radius of the particle used to form the porous material. For example, in some cases, a porous material may have an average pore size of about 1/10 the radius of the particle. In one particular example, the pore size of a porous material comprising 1 micron diameter spheres was about 50-100 nm.

In some cases, the particles are microspheres; in some instances, the microspheres comprise a polymer, such as polystyrene. In other cases, the particles can be beads, colloids, nanoparticles, a resin (e.g., an ion-exchange resin), or other entities. All, or a combination of these and/or other particles, may also be used. It may be desirable, in come applications, to functionalize the particles with a moiety that may bind with, attract, or repel, a particle in the suspension prior to formation of the porous material. For example, a particle may comprise a moiety that can bind with a binding partner in the suspension (i.e., the moiety can also be a binding partner). The term “binding partner” refers to a molecule that can undergo binding with a particular molecule. Biological binding partners are examples, e.g., protein A is a binding partner of the biological molecule IgG, and vice versa. In other instances, the porous material may comprise a gel such as an agarose gel, an alginate gel, a hydrogel, a pH- or temperature-responsive gel, or any other material that may act as a porous material. Components of a porous material may also combine with components from a suspension to form a more closely packed filter bed. For example, the filtration efficiency of some porous beds may improve after the bed has been conditioned by filtering a quantity of sample through the bed. This conditioning of the porous material can result in a filtrate with fewer or smaller residual particles than without the conditioning step.

In one set of embodiments, the particles defining a porous material of a filtering system of the invention are the same as components desirably removed via a filtration process involving the filtering system. I.e., a filter can first be formed, or conditioned, by collecting particles at locations within the system as shown in FIG. 5, and then a fluid containing those particles (and/or similar particles) can be introduced into the system and those particles substantially removed, and a filtrate recovered

In one aspect of the invention, a method of filtering a sample is provided. The method may include, for instance, flowing a suspension comprising a fluid and at least a first particle through a first microfluidic channel of a microfluidic filter, allowing a portion of the fluid to pass through at least a second channel, where at least a portion of the second channel comprises a porous material preventing the particle from reaching a first filtrate outlet (or a porous material that is otherwise appropriately positioned), and collecting the portion of the fluid in the first filtrate outlet which is in fluid communication with the second channel. In some cases, the suspension may be filtered by size exclusion, for instance, by excluding the particle within the suspension from the pores of the porous material. In one embodiment, the particle of the suspension may have a diameter of less than about 5 microns. In another embodiment, the particle of the suspension may have a diameter of less than about 1 micron, and in yet another embodiment, the particle of the suspension may have a diameter of less than 0.1 microns, or less than 50 nm. In other cases, the particle of the suspension may be prevented from passing through the second channel due to binding or reacting with a moiety disposed in the second channel. Binding may occur covalently, for example, by forming a chemical bond with a species in the porous material; or, binding may occur noncovalently, for example, by binding with a species in the porous material due to van der Waals interactions, hydrophilic or hydrophobic interactions, magnetic interactions, or the like. In another embodiment, the particle of the suspension may be excluded from the second channel by charge. All or a combination of these interactions may also be used to exclude a particle. In another embodiment, a method of filtering a sample may include forming a porous material by mixing particles such as beads, or similar, with a sample, and then running the entire mixture through the device to form the porous material and filtering the sample at the same time.

In some cases, it may be desirable to flush out a porous material in a device and form a new porous material, i.e., to re-use a device. This can be possible by reversing the flow in the device, for example, by forcing fluid through the secondary or tertiary filtering channels and into a first main channel.

A wide range of suspensions may be filtered or concentrated in accordance with the present invention. Non-limiting examples of suspensions include body fluids such as whole blood, saliva, and urine, harvest cell suspensions, cell lysates, fermentation broths, cell nutrient media, fruit juice concentrates, and environmental waste waters. The microfluidic filter may be pretreated or conditioned depending on the intended use of the filter. For instance, applications involving the life sciences, such as separation of plasma from whole blood, may require sterilization of the filter prior to use. Non-limiting examples of sterilization methods include treating a device with ultraviolet radiation, chemicals, plasma, or by using an autoclave.

Different modes of operating the filter may also be implemented depending on the application. For example, continuous monitoring of filtrate collected at the filtrate outlet may be possible by connecting the filtrate outlet to a detection apparatus such as a mass spec analyzer. Thus, the presence or absence of a compound in the filtrate may be monitored over time.

In another embodiment, it may be desirable to recirculate fluid in the filter in order to concentrate the suspension or obtain a greater amount of filtrate, e.g., by pumping the fluid from outlet 1-10 to inlet 1-5 of filter 1-1 of FIG. 1, whereby fluid can become continually more concentrated, in the main channel, in component inhibited from passage through secondary, filtering channels. In some instances, a device may comprise an array of filters, each of which may be fluidically interconnected or separate, and may have the same or different modes of operation. Interconnected filters may, for example, be connected in parallel, in series, and/or three-dimensionally (e.g., stacked on top of one another).

A variety of pumps for pumping and/or recirculating fluid may be used in conjunction with the device. Pumps may be internal and/or external to the device and may be integrated with the structure of the microfluidic filter. Non-limiting examples of pumps include electrical pumps and syringe pumps. Fluid may also be caused to flow by gravity, by connecting the device to a pressurized gas tank or a vacuum chamber, or by compressing fluid manually through a syringe. Typically, pumps are located upstream of a primary main channel and vacuum sources downstream of the primary channel. Pumps and vacuum sources may also be in fluid communication with secondary or tertiary channels so that, for example, filtrate may be urged through these channels.

A variety of pressures and/or flow rates may be used in accordance with the present invention depending on the application of use. The pressure at which the suspension is driven through the channel system only determines the rate at which the filtrate is collected and does not have an effect on the fraction of fluid collected. Therefore, the filter can be run at high driving pressures to obtain samples more quickly without effecting the performance of the filter. In one embodiment, a flow rate used for flowing the suspension through a microfluidic system may be higher than about 2000 microliters per hour. In another embodiment, the flow rate can be higher than about 5000 microliters per hour. In some instances, the flow rate can be greater than about 7000 microliters per hour, greater than about 9000 microliters per hour or greater than about 35,000 microliters per hour.

One procedure for fabricating a microfluidic channel in a structure is described below. It should be understood that this is by way of example only, and those of ordinary skill in the art will know of additional techniques suitable for forming microfluidic structures, for instance, as discussed in U.S. Pat. Nos. 6,719,868, 6,686,184, and 6,645,432, each of which is incorporated herein by reference.

In one embodiment, a microfluidic channel may be made by applying a standard molding article against an appropriate master. For example, microchannels can be made in PDMS by casting PDMS prepolymer (Sylgard 184, Dow Corning) onto a patterned photoresist surface relief (a master) generated by photolithography. The pattern of photoresist may comprise the channels having the desired dimensions. After curing for 1 h at 65° C., the polymer can be removed from the master to give a free-standing PDMS mold with microchannels embossed on its surface.

Inlets and/or outlets can be cut out through the thickness of the PDMS slab. To form substantially enclosed microchannels, the microfluidic channels may be sealed in the following way. First, the PDMS mold and a flat slab of PDMS (or any other suitable material) can be placed in a plasma oxidation chamber and oxidized for 1 minute. The PDMS structure can then be placed on the PDMS slab with the surface relief in contact with the slab. The irreversible seal is a result of the formation of bridging siloxane bonds (Si—O—Si) between the two substrates that result from a condensation reaction between silanol (SiOH) groups that are present at both surfaces after plasma oxidation.

The following examples are intended to illustrate certain embodiments of the present invention, but are not to be construed as limiting and do not exemplify the full scope of the invention.

### EXAMPLE 1

Example 1 demonstrates that a microfluidic filter can be fabricated using a one step soft-lithography method as described in U.S. Pat. No. 6,686,184. A brief description of this method is as follows. A chrome mask including a design of the microfilter channels was fabricated. A two micron high layer of SU-8 was spin coated onto a silicon wafer. The SU-8 was shined with UV light and developed. The wafer was recoated with a 25 micron layer of SU-8 and the channels of the filter were developed. Twenty-five grams of PDMS were poured over the silicon mold and degassed in a vacuum chamber. The inlet and the outlet holes were punched with a specially prepared twenty-gauge needle. The PDMS device was then sealed to a PDMS slab by oxidizing both pieces using an air plasma chamber. The inlet and the outlet holes were connected with PE-20 tubing.

In one example, a device similar to the one shown in FIG. 1 was fabricated. The device comprised a first channel 1-100, rectangular in cross-section, having a height of 27 μm, a width of 200 μm, and a length of 5000 μm. A plurality of secondary channels 1-200 and 1-300, all in fluid communication with the first channel, were fabricated having a height of 2 μm, a width of 5 μm and a length of 300 μm. The secondary channels were substantially perpendicular to the first channel. The difference in heights between the secondary channels and the first channel was engineered through a two-step mask development process; this difference in height between the channels may play a significant role in providing filtration and in impeding clogging in the filter.

### EXAMPLE 2

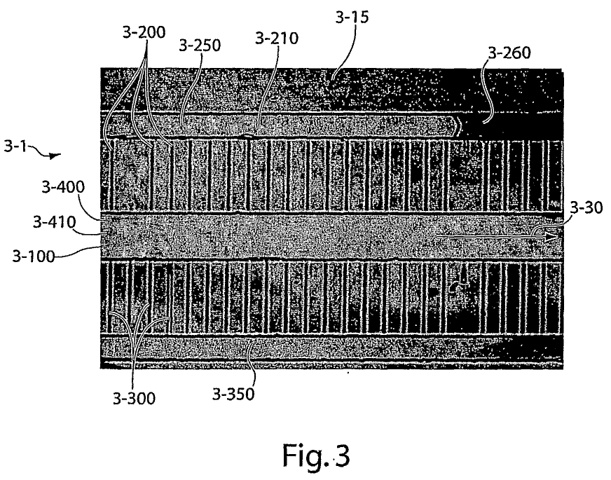

Example 2 shows that a suspension of microspheres can be filtered from a fluid using the device of Example 1. A 0.1% w/v suspension of 4 μm fluorescent polystyrene microspheres was introduced into the device via inlet 1-5 and then run at various pressures through the device. Argon from a pressurized gas cylinder was used to apply the driving pressure. FIG. 3 is a close-up (10×) photograph of the device of Example 1, showing entry of the filtrate into secondary channels 3-200 and 3-300. The fluid from the suspension was dyed with 1 mg/mL of fluorescein to improve visibility; the filtrate of the suspension can be seen displacing air 3-260 in the first filtrate collection channel 3-250. In this example, the suspension was driven at a flow rate of 9000 microliters per hour. The microspheres 3-410 can be seen as streaks due to the high flow rate in the first channel 3-100. About 7% of the suspension was extracted as filtrate through the two filtration channels 1-250 and 1-350, and collected at filtrate outlets 1-240 and 1-340. Additional filtrate could be collected by recycling the suspension through the device one or more times.

A suspension comprising smaller beads such as 2 μm diameter microspheres was also filtered using the device of Example 1 using the procedure described above. About 7% of the suspension was extracted as filtrate through the two filtration channels. In both cases, the removal of filtrate resulted in an increase of particle concentration in the suspension.

### EXAMPLE 3

The following example demonstrates that porous materials can be formed in the device of Example 1 and that the device comprising the porous materials can be used to filter a sample of whole blood. To form a porous material comprising 1 μm beads, a 0.1% suspension of 1 μm beads was introduced into the device via an inlet to a first main channel. The suspension was flowed through the device using argon from a pressurized gas cylinder. FIG. 5 (63× magnification of the actual device) shows porous layers 5-410, 5-415 and 5-420 being formed in secondary channels 5-200, 5-205, 5-210 at the junction, or interface, of first channel 5-100. The porous layers were formed from random close packing of the spherical beads in different configurations in the channels. For instance, in some cases, the spheres 5-405 packed at the inlet of a secondary channel 5-210. In other cases, the spheres 5-405 comprising porous layer 5-420 packed inside a portion of secondary channel 5-210.

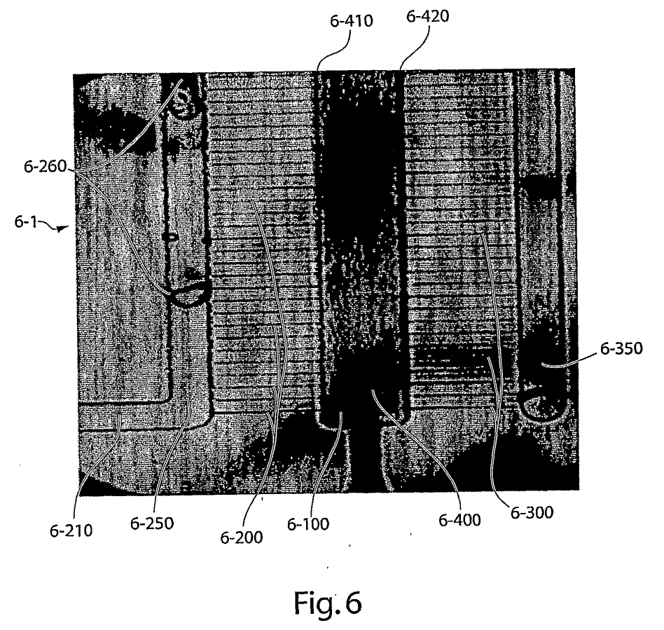

After the porous layers were formed, the remaining suspension was removed from the device via an outlet connected to the first channel 5-100. A sample of whole blood was then introduced into the device via an inlet, e.g., inlet 1-5 of FIG. 1. The sample was flowed at a driving pressure of 30 psi. FIG. 6 is a 10× photomicrograph showing the cell-free plasma 6-210 entering first filtrate collection channel 6-250 and second filtrate collection channel 6-350 while displacing air which can be seen as bubbles 6-260. An analyzable quantity of cell-free plasma, about 1% of volume injected, was collected at the filtrate outlets.

### EXAMPLE 4

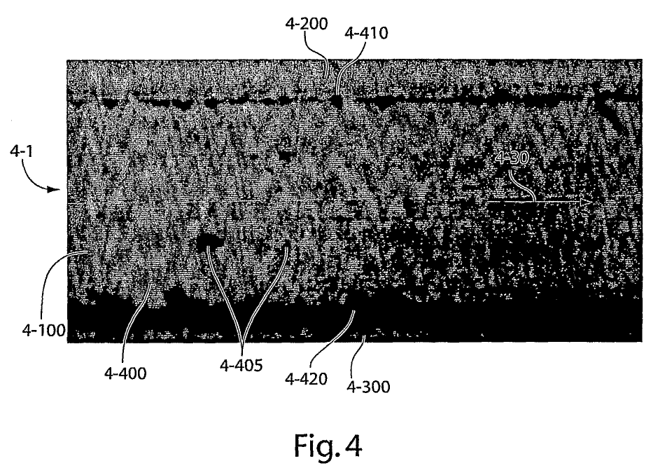

The following example demonstrates that particles having a diameter greater than a cross-sectional dimension of a secondary channel may not clog the secondary channels. For instance, FIG. 4 (a 20× magnification of the actual device) shows a filter 4-1 comprising a first channel 4-100 in fluid communication with secondary channels 4-200 and 4-300, both sets of channels having a height of 2 μm, a width of 5 μm and a length of 300 μm. A suspension 4-400 comprising particles of 4 μm fluorescent microspheres 4-405 was flowed in channel 4-100 in the direction shown by arrow 4-30 and was driven by a driving pressure of 15 psi. Transient microspheres 4-410 adhered to the opening of the second channel 4-200 but were quickly washed away by the tangential flow. This unclogging mechanism was more pronounced for higher driving pressures.

### EXAMPLE 5

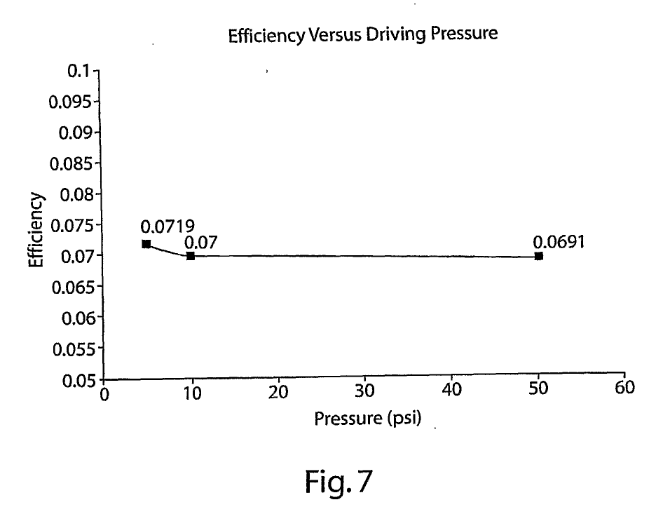

The following experiment demonstrates that the pressure at which a suspension is driven through a filter determines the rate at which the filtrate is collected, and does not have an effect on the fraction of fluid collected. This indicates that suspensions can be run at high flow rates in order to obtain samples more quickly without affecting the performance of the device. FIG. 7 shows the relationship between the efficiency and the driving pressure in a filter, such as the one shown in 6-1. Efficiency of the filter is defined as the ratio of filtrate to suspension; in other words, it is the ratio of the amount of filtrate collected to the amount of suspension injected. Efficiency depends in part on the geometry of the secondary filtering channels. FIG. 7 illustrates that the pressure at which the suspension is driven through the channels does not have an effect on the fraction of the filtrate collected. This was true for a wide range of pressures used (e.g., 5-50 psi).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of”, when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A microfluidic filter, comprising:
a structure comprising a first microfluidic channel having an inlet and an outlet;
a second microfluidic channel branching from the first channel and in fluid communication with a first filtrate outlet; and
a porous material immobilized in a portion but not all of the second channel.

2. The microfluidic filter of claim 1 wherein the structure is elastomeric.

3. (canceled)

4. The microfluidic filter of claim 1 wherein the second channel is substantially perpendicular to the first channel.

5. The microfluidic filter of claim 1 wherein the second channel has a cross-sectional area that is smaller than a cross-sectional area of the first channel.

6. The microfluidic filter of claim 1 wherein the second channel has a cross-sectional dimension that is smaller than a cross-sectional dimension of the first channel.

7. The microfluidic filter of claim 1 wherein the second channel has a cross-sectional dimension of less than about 50 microns.

8-11. (canceled)

12. The microfluidic filter of claim 1 comprising greater than 10 additional channels in fluid communication with the first channel and with the first filtrate outlet.

13-14. (canceled)

15. The microfluidic filter of claim 1 wherein the second channel comprises a first section having a first cross-sectional area and a second section having a second cross-sectional area wherein the first cross-sectional area is smaller than the second cross-sectional area.

16. (canceled)

17. The microfluidic filter of claim 1 further comprising a first filtrate collection channel disposed between the first filtrate outlet and the second channel.

18-22. (canceled)

23. The microfluidic filter of claim 1 further comprising a third channel that is disposed between a second filtrate outlet and the first channel, and which is separated from the second channel by the first channel, the third channel having a cross-sectional dimension that is smaller than a cross-sectional dimension of the first channel.

24. (canceled)

25. The microfluidic filter of claim 1 wherein the porous material comprises a plurality of particles.

26. The microfluidic filter of claim 1 wherein the porous material comprises particles having a diameter less than a cross-sectional dimension of the first channel and greater than a cross-sectional dimension of the second channel.

27-31. (canceled)

32. The microfluidic filter of claim 1 wherein the porous material comprises particles in the form of microspheres.

33. (canceled)

34. The microfluidic filter of claim 1 wherein the porous material comprises a moiety that can bind with a binding partner in the suspension.

35. The microfluidic filter of claim 1 wherein the porous material comprises two or more particles, each particle having a different diameter.

36. The microfluidic filter of claim 1 wherein the porous material comprises a gel.

37. The microfluidic filter of claim 1 wherein the porous material comprises magnetic particles.

38. The microfluidic filter of claim 1 further comprising a system that recirculates fluid from the outlet of the first channel into the inlet of the first channel.

39. The system comprising an array of the filters of claim 1.

40. (canceled)

41. The microfluidic filter of claim 1 wherein the porous material has an average pore size of less than about 1 micron.

42-190. (canceled)

191. A method of forming a porous material in a microfilter, the method comprising:
flowing a suspension comprising a plurality of particles through a first microfluidic channel of a microfluidic filter; and
retaining at least a portion of the particles in a second channel branching from the first channel to form a packed association of particles which form the porous material.

192-194. (canceled)

195. The method of claim 191 wherein a flow rate used for flowing the suspension is higher than about 7000 microliters per hour.

196-198. (canceled)

199. The method of claim 191 further comprising recirculating fluid from an outlet of the first channel into an inlet of the first channel.

200. (canceled)

201. The method of claim 191 wherein the particles have a diameter of less than about 5 microns.

202-203. (canceled)

204. A method of claim 191, further comprising flowing a second suspension comprising a plurality of particles through the first microfluidic channel, wherein the particles of the second suspension are smaller than the particles of the first suspension, and retaining at least a portion of the particles from the second suspension in the second channel.
